(19) United States
(12) Patent Application Publication
(10) Pub. No.: US 2026/0319483 A1
(43) Pub. Date: Oct. 15, 2026

(54) PSYCHOACOUSTICS-BASED MACHINE LEARNING CLASSIFIERS FOR ANOMALY DETECTION OF OIL AND GAS PROCESS EQUIPMENT

(71) Applicant: Schlumberger Technology Corporation, Sugar Land, TX (US)

(72) Inventors: Fei Song, Houston, TX (US); Juan Alvarez, Houston, TX (US); Christopher Jinks, Delhi, LA (US); Edward Gutierrez Jr., Houston, TX (US); Judy Zhuqing Dong, Houston, TX (US)

(21) Appl. No.: 19/179,104

(22) Filed: Apr. 15, 2025

(51) Int. Cl. G05B 23/02

(52) U.S. Cl. CPC G05B 23/024; G05B 23/0221

(57) ABSTRACT

A method for detecting anomalous behavior in equipment includes training a machine learning model to classify features and the anomalous behavior in the equipment using psychoacoustic data collected from a first set of machines. The method also includes collecting the psychoacoustic data from a second set of machines including receiving the psychoacoustic data from a microphone-carrying device, the microphone-carrying device operating in proximity to the second set of machines. The method also includes detecting the anomalous behavior of the second set of machines using the machine learning model based upon the psychoacoustic features.

### BACKGROUND

Oil and gas installations receive regular maintenance and tuning to both minimize unforeseen breakdowns or failures during operation and to extend the overall lifespan of the machines. The equipment is maintained and inspected to enable sustainable, efficient and safe production. Accuracy in fault detection is addressed because failure to detect faults in process equipment may result in consequences such as repair costs, production downtime, and nonproductive time, and health and safety implications for workers. When human physical presence and intervention in industrial process plants is limited, inspection and maintenance operations may be converted to condition-based predictive operations that may reduce the in-operation failure rate. Autonomous robotics may be used to handle as many tasks as possible. Process equipment in the oil and gas facility may emit a wide range of sounds, often culminating in noise. Functional equipment may create a first set of sounds, while malfunctioning equipment may create a second set of sounds, referred to herein as anomalous sounds. Anomalous sound detection may identify whether the sound emitted from equipment is a member of the first set of sounds, or an anomalous sound. An acoustic sensor or microphone may be integrated in the payload of robots, which may be used to collect audio data for anomaly detection of the process equipment in an autonomous manner.

Psychoacoustics is the study of how humans perceive sound. Psychoacoustics combines the physiology of sound, i.e. how the body receives sound, with the psychology of sound, i.e. how the brain interprets sound. These sciences enable understanding of how and why sounds affect people differently. A psychoacoustic indicator is a measurement of a sound's physical properties, such as loudness, roughness, sharpness, or fluctuation strength, that is used to describe how a person perceives sound. Psychoacoustic indicators may be used in machinery anomaly detection. Artificial intelligence (AI) and machine learning (ML) may use psychoacoustic indicators to enable detection of process equipment malfunctions.

What is needed are systems and methods for acoustic anomaly detection of oil and gas process equipment using psychoacoustics features-based machine learning. What is needed is a workflow for computing psychoacoustic indicators as input features to train machine learning classifiers, and using the classifiers to automatically identify anomaly for oilfield process equipment.

### SUMMARY

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. One general aspect includes a method operable to detect anomalous behavior in equipment. The method includes training a machine learning model to classify features and the anomalous behavior in the equipment using psychoacoustic data collected from a first set of machines, and collecting the psychoacoustic data from a second set of machines including receiving the psychoacoustic data from a microphone-carrying device, the microphone-carrying device operating in proximity to the second set of machines. The method also includes detecting the anomalous behavior of the second set of machines using the machine learning model based upon the psychoacoustic data. Other embodiments of this aspect include corresponding computer systems, apparatus, and computer programs recorded on one or more computer storage devices, each configured to perform the actions of the methods.

One general aspect includes a computing system operable to detect anomalies in equipment. The computing system also includes one or more processors, and a memory system that may include one or more non-transitory computer-readable media storing instructions that, when executed by at least one of the one or more processors, cause the computing system to perform operations. The operations may include training a machine learning model to classify features and the anomalous behavior in the equipment using psychoacoustic data collected from a first set of machines, collecting the psychoacoustic data from a second set of machines including receiving the psychoacoustic data from a microphone-carrying device, the microphone-carrying device operating in proximity to the second set of machines, and detecting the anomalous behavior of the second set of machines using the machine learning model based upon the psychoacoustic data. Other embodiments of this aspect include corresponding computer systems, apparatus, and computer programs recorded on one or more computer storage devices, each configured to perform the actions of the methods.

One general aspect includes a non-transitory computer-readable medium storing instructions that, when executed by one or more processors of a computing system, cause the computing system to perform operations operable to detect anomalous behavior in equipment. The operations include training a machine learning model to classify features and the anomalous behavior in the equipment using psychoacoustic data collected from a first set of machines. The operations also include collecting the psychoacoustic data from a second set of machines including receiving the psychoacoustic data from a microphone-carrying device, the microphone-carrying device operating in proximity to the second set of machines. The operations also include detecting the anomalous behavior of the second set of machines using the machine learning model based upon the psychoacoustic data. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, in accordance with embodiments of the present disclosure.

FIGS. 2-5 illustrate schematic views of an oilfield having subterranean formation containing reservoir therein in accordance with embodiments of the present disclosure.

FIG. 6 illustrates a schematic view, partially in cross section, of an oilfield 200 having data acquisition tools in accordance with embodiments of the present disclosure.

FIG. 7 illustrates an oilfield 300 for performing production operations in accordance with embodiments of the present disclosure.

FIG. 8 illustrates the component(s) of the seismic waves that may be reflected and converted by the seafloor surface and seismic wave reflections, and may be received by a plurality of seismic receivers.

FIG. 9 illustrates a marine electromagnetic survey system in accordance with embodiments of the present disclosure.

FIG. 10 illustrates a seismic system in accordance with embodiments of the present disclosure in which a plurality of tow vessels enables seismic profiling.

FIG. 11 illustrates a system and method for psychoacoustics-based machine learning classifiers for anomaly detection of oil and gas process equipment in accordance with embodiments of the present disclosure.

FIG. 12 illustrates audio data collection in a production facility in accordance with embodiments of the present disclosure.

FIGS. 13A and 13B illustrate raw audio signals from hot oil pumps.

FIG. 14 illustrates boxplots grouped by motor fault status between psychoacoustic features for hot oil pumps.

FIG. 15 illustrates a confusion matrix for anomalous sound detection with example psychoacoustics-based machine learning classifier evaluated on test dataset of hot oil pumps.

FIG. 16 illustrates a flowchart of a method in accordance with embodiments of the present disclosure.

FIG. 17 illustrates a schematic view of a computing system for performing at least a portion of the method(s) herein, in accordance with embodiments of the present disclosure.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

Systems and methods in accordance with embodiments of the present disclosure perform acoustic anomaly detection of oil and gas process equipment using psychoacoustics features-based machine learning. In some configurations, systems and methods in accordance with embodiments of the present disclosure may be developed as a model, and may be applied to, for example, hot oil pumps and other oil and gas process equipment, such as cooling fans, motors, membrane separators, valves, compressors, heat exchange, and pipeline gas leakage that could generate abnormal noise.

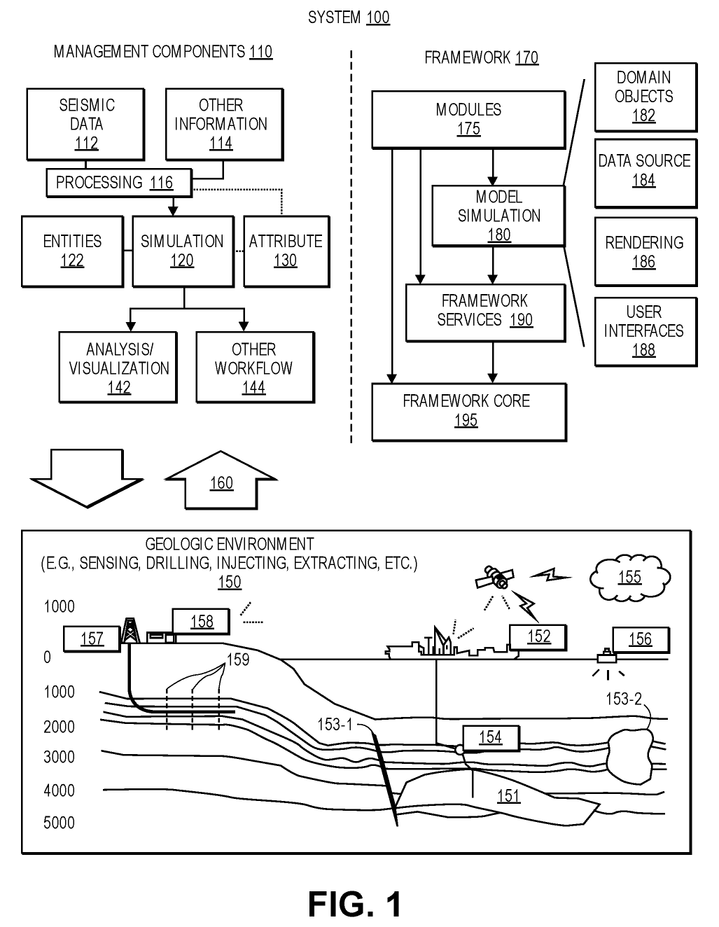

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT^{®} .NET^{®} framework (Redmond, Washington), which provides a set of extensible object classes. In the .NET^{®} framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE^{TM} reservoir simulator (SLB, Houston Texas), the INTERSECT^{TM} reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL^{®} seismic to simulation software framework (SLB, Houston, Texas). The PETREL^{®} framework provides components that allow for optimization of exploration and development operations. The PETREL^{®} framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN^{®} framework environment (SLB, Houston, Texas) allows for integration of add-ons (or plug-ins) into a PETREL^{®} framework workflow. The OCEAN^{®} framework environment leverages .NET^{®} tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN^{®} framework where the model simulation layer 180 is the commercially available PETREL^{®} model-centric software package that hosts OCEAN^{®} framework applications. In an example embodiment, the PETREL^{®} software may be considered a data-driven application. The PETREL^{®} software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL^{®} software, for example, that operates on seismic data, seismic attribute(s), etc. As an example, a workflow may be a process implementable in the OCEAN^{®} framework. As an example, a workflow may include one or more worksteps that access a module such as a plug-in (e.g., external executable code, etc.).

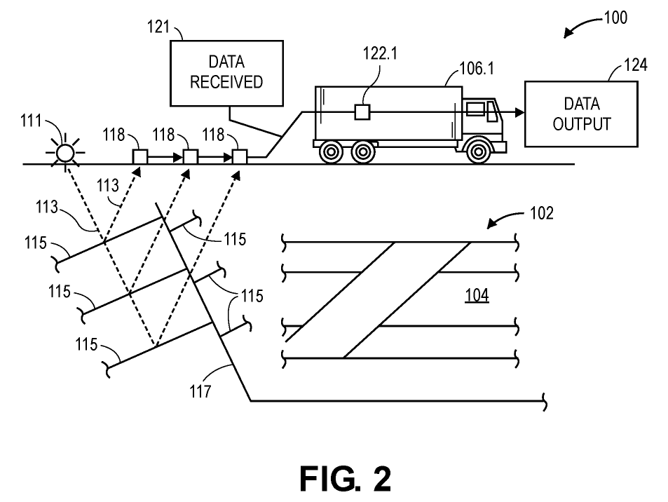

The field configurations of FIGS. 2-5 are intended to provide a brief description of an example of a field usable with oilfield application frameworks. Part of, or the entirety, of the oilfield may be on land, water, and/or sea. Also, while a single field measured at a single location is depicted, oilfield applications may be utilized with any combination of one or more oilfields, one or more processing facilities and one or more wellsites.

FIG. 2 illustrates a survey operation being performed by a survey tool, such as seismic truck 106.1, to measure properties of the subterranean formation. The survey operation is a seismic survey operation for producing sound vibrations. In FIG. 2, one such sound vibration, e.g., sound vibration 113 generated by source 111, reflects off horizons 115 in earth formation 117. A set of sound vibrations is received by sensors, such as geophone-receivers 118, situated on the earth's surface. The data received 121 are provided as input data to a computer 122.1 of a seismic truck 106.1, and responsive to the input data, computer 122.1 generates seismic data output 124. This seismic data output may be stored, transmitted or further processed as desired, for example, by data reduction.

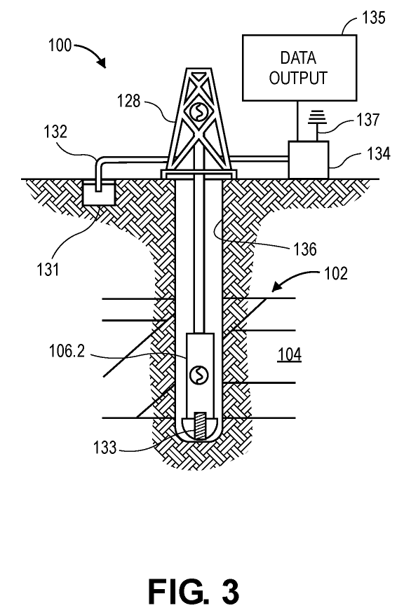

FIGS. 3-5 illustrate tools used to measure properties of an oilfield. It will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors may be located at various positions along the wellbore and/or the monitoring tools to collect and/or monitor the desired data. Other sources of data may also be provided from offsite locations.

FIG. 3 illustrates a drilling operation being performed by drilling tools 106.2 suspended by rig 128 and advanced into subterranean formations 102 to form wellbore 136. Mud pit 131 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield, for example at the surface unit 134, and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors, such as gauges, may be positioned about oilfield to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

The wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors may be collected by surface unit 134 and/or other data collection sources for analysis or other processing. The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield or other locations. Surface unit 134 may also be provided with or functionally connected to one or more controllers (not shown) for actuating mechanisms at the oilfield. Surface unit 134 may then send command signals to the oilfield in response to data received. Surface unit 134 may receive commands via transceiver 137 or may itself execute commands to the controller. A processor may be provided to analyze the data (locally or remotely), make the decisions and/or actuate the controller. In this manner, the oilfield may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

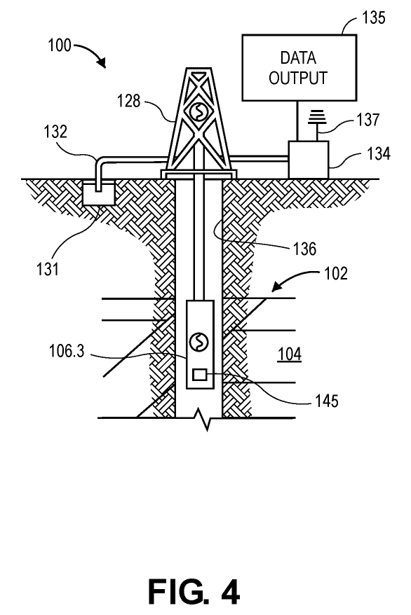

FIG. 4 illustrates a wireline operation being performed by wireline tool 106.3 suspended by rig 128 and into wellbore 136. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 145 that sends and/or receives electrical signals to surrounding subterranean formations 102 and fluids therein.

Wireline tool 106.3 may be operatively connected to, for example, geophones 118 and a computer 122.1 of a seismic truck 106.1 (FIG. 2). Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors, such as gauges, may be positioned about the oilfield to collect data relating to various field operations as described previously. As shown, a sensor is positioned in wireline tool 106.3 to measure downhole parameters which relate to, for example porosity, permeability, fluid composition and/or other parameters of the field operation.

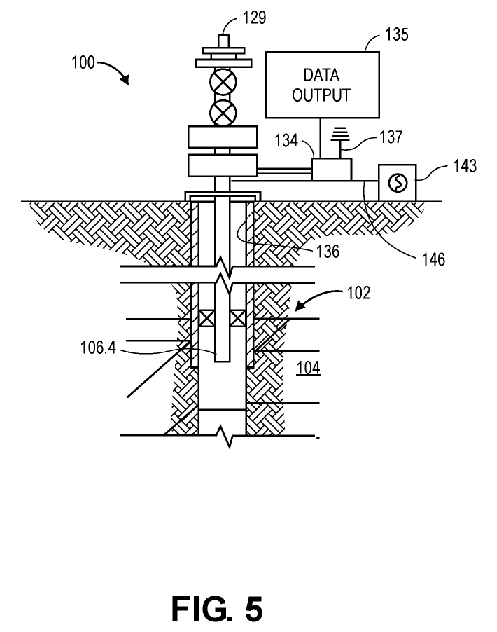

FIG. 5 illustrates a production operation being performed by production tool 106.4 deployed from a production unit or Christmas tree 129 and into completed wellbore 136 for drawing fluid from the downhole reservoirs into surface facilities 143. The fluid flows from reservoir 104 through perforations in the casing (not shown) and into production tool 106.4 in wellbore 136 and to surface facilities 143 via gathering network 146.

Sensors, such as gauges, may be positioned about the oilfield to collect data relating to various field operations as described previously. As shown, the sensor may be positioned in production tool 106.4 or associated equipment, such as Christmas tree 129, gathering network 146, surface facility 143, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

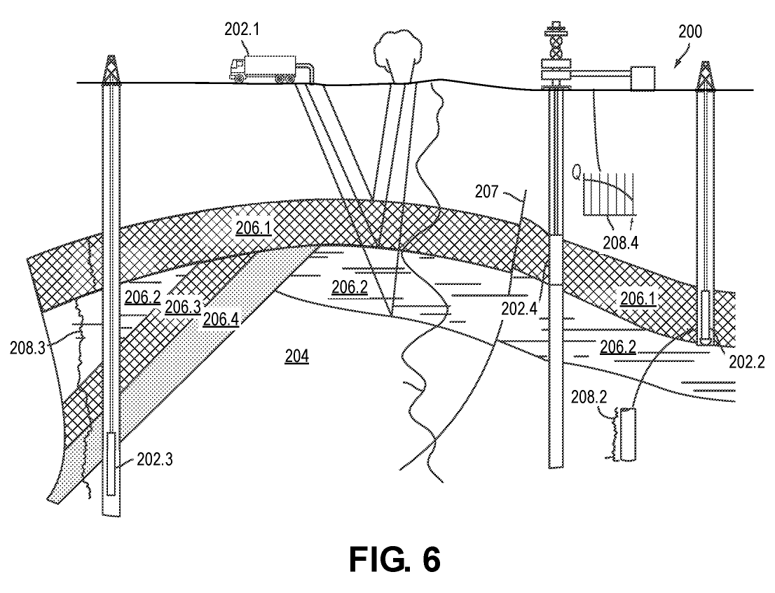

FIG. 6 illustrates a schematic view, partially in cross section, of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2-5, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean formation 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 6, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

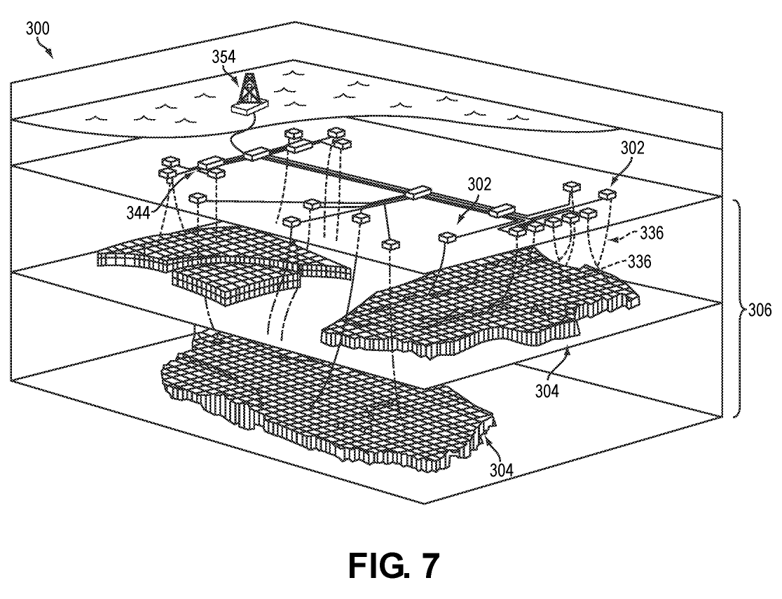

FIG. 7 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 7 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

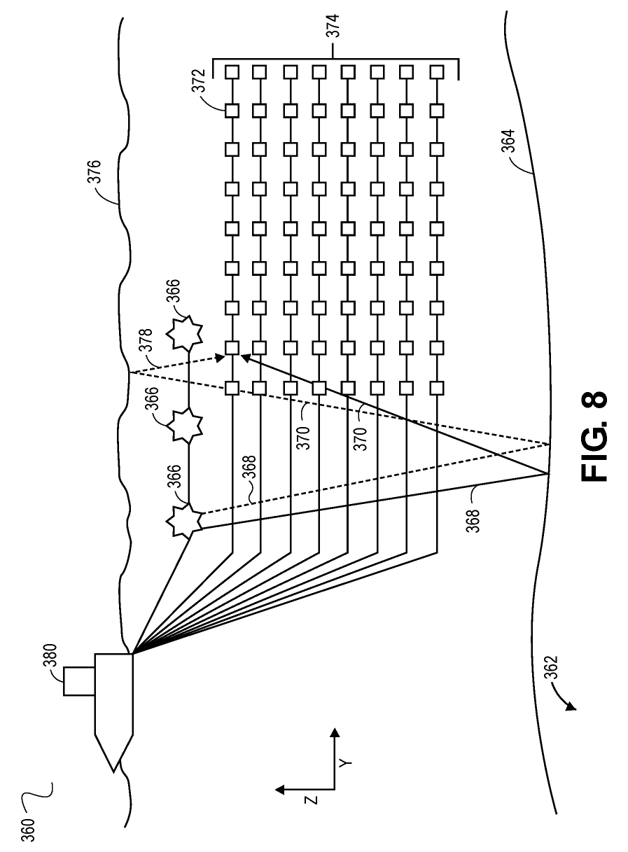

FIG. 8 illustrates the component(s) of the seismic waves 368 that may be reflected and converted by the seafloor surface 364 (i.e., reflector) and seismic wave reflections 370, and may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors 366, some of which may include dipping events, and may generate multiple reflections (including wave conversion) for receipt by the seismic receivers 372. In one implementation, the seismic data may be processed to generate a seismic image of the subsurface 362.

Typically, marine seismic acquisition systems tow each streamer in streamer array 374 at the same depth (e.g., 5-10m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 8 illustrates eight streamers towed by vessel 380 at eight different depths. The depth of each streamer may be controlled and maintained using the birds disposed on each streamer.

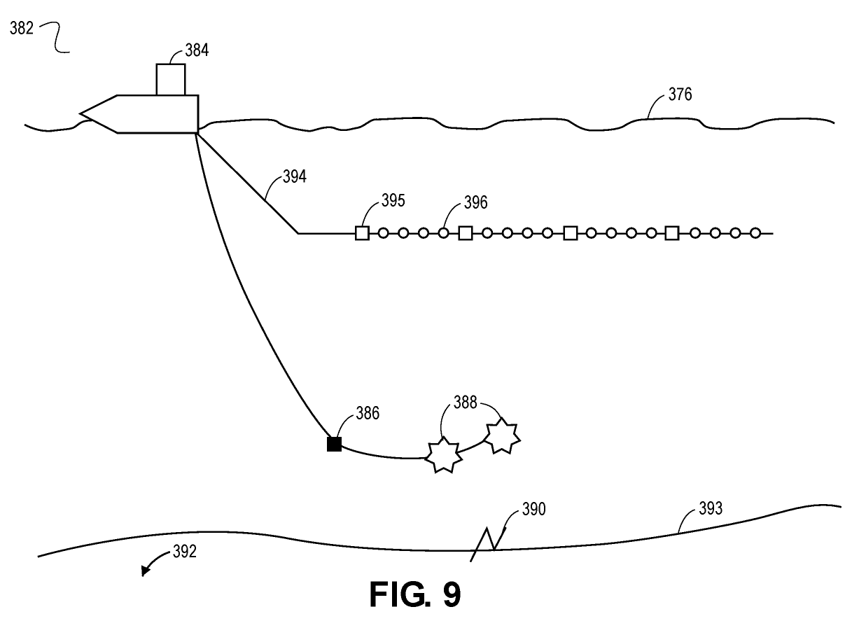

FIG. 9 illustrates a marine electromagnetic survey system 382 in accordance with implementations of various technologies described herein. The electromagnetic survey system 382 may use controlled-source electromagnetic (CSEM) survey techniques, but other electromagnetic survey techniques may also be used. Marine electromagnetic surveying may be performed by a survey vessel 384 that moves in a predetermined pattern along the surface 385 of a body of water such as a lake or the ocean. The survey vessel 384 is configured to pull a towfish (an electric source) 386, which is connected to a pair of electrodes 388. During the survey, the vessel may stop and remain stationary for a period of time while obtaining measurements, while in some circumstances, the vessel may remain underway while obtaining measurements.

At the source 386, a controlled electric current may be generated and sent through the electrodes 388 into the seawater. For instance, the electric current generated may be in the range between about 0.01 Hz and about 20 Hz. The current creates an electromagnetic field 390 in the subsurface 392 to be surveyed below the sea floor 393. The electromagnetic field 390 may also be generated by magneto-telluric currents instead of the source 386. The survey vessel 384 may also be configured to tow a sensor cable 394. The sensor cable 394 may be a marine towed cable. The sensor cable 394 may contain sensor housings 395, telemetry units 396, and current sensor electrodes (not illustrated). The sensor housings 395 may contain voltage potential electrodes for measuring the electromagnetic field 390 strength created in the subsurface area 392 during the surveying period. The current sensor electrodes may be used to measure electric field strength in directions transverse to the direction of the sensor cable 394 (the y- and z-directions). The telemetry units 396 may contain circuitry configured to determine the electric field strength using the electric current measurements made by the current sensor electrodes. While a marine-based electromagnetic survey is described in regard to FIG. 9, a land-based electromagnetic survey may also be used in accordance with implementations of various techniques described herein.

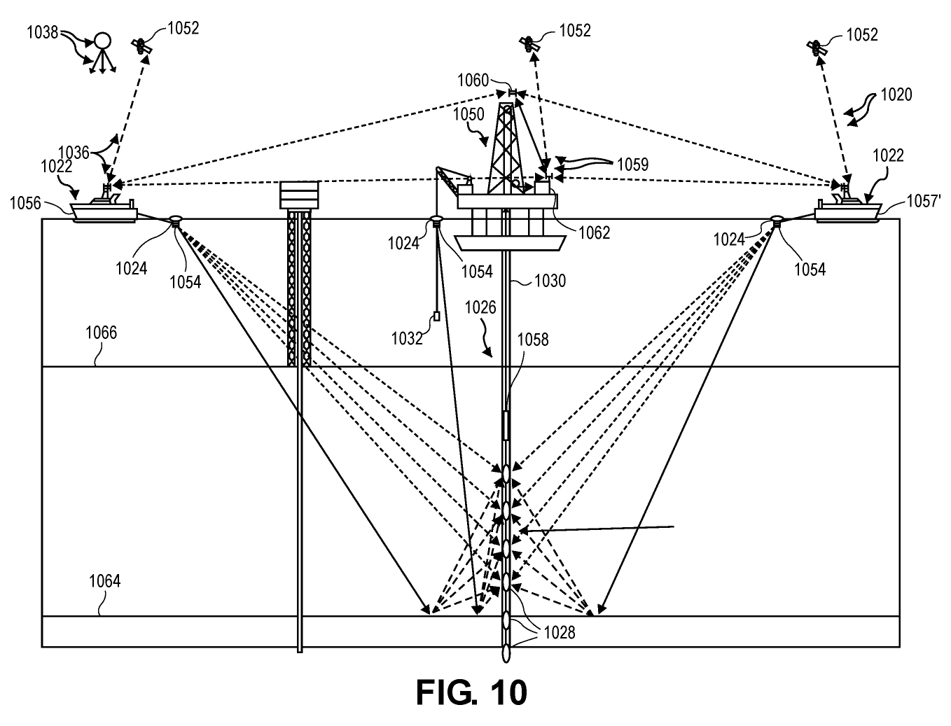

FIG. 10 illustrates an embodiment of seismic system 1020 in which a plurality of tow vessels 1022 is employed to enable seismic profiling, e.g., three-dimensional vertical seismic profiling or rig/offset vertical seismic profiling. In FIG. 10, a marine system is illustrated as including a rig 1050, a plurality of vessels 1022, and one or more acoustic receivers 1028. Although a marine system is illustrated, other embodiments of the disclosure may not be limited to this example. A person of ordinary skill in the art will recognize that teachings of the disclosure may be used in land or offshore systems. However, offshore systems are described herein to simplify the disclosure and to facilitate explanation.

Although two vessels 1022 are illustrated in FIG. 10, a single vessel 1022 with multiple source arrays 1024 or multiple vessels 1022 each with single or multiple sources 1024 may be used. In some applications, at least one source/source array 1024 may be located on the rig 1050 as represented by the rig source in FIG. 10. As the vessels 1022 travel on predetermined or systematic paths, their locations may be recorded through the use of navigation system 1036. In some cases, the navigation system 1036 utilizes a global positioning system (GPS) 1038 to record the position, speed, direction, and other parameters of the tow vessels 1022.

As illustrated, the global positioning system 1038 may utilize or work in cooperation with satellites 1052 which operate on a suitable communication protocol, e.g. VSAT communications. The VSAT communications may be used, among other things, to supplement VHF and UHF communications. The GPS information may be independent of the VSAT communications and may be input to a processing system or other suitable processors to predict the future movement and position of the vessels 1022 based on real-time information. In addition to predicting future movements, the processing system also may be utilized to provide directions and coordinates as well as to determine initial shot times, as described above. A control system effectively utilizes the processing system in cooperation with a source controller and a synchronization unit to synchronize the sources 1024 with the downhole data acquisition system 1026.

As illustrated, the one or more vessels 1022 each tow one or more acoustic sources/source arrays 1024. The source arrays 1024 include one or more seismic signal generators 1054, e.g., air guns, configured to create a seismic/sonic disturbance. In the embodiment illustrated, the tow vessels 1022 include a master source vessel 1056 (Vessel A) and a slave source vessel 1057 (Vessel B). However, other numbers and arrangements of tow vessels 1022 may be employed to accommodate the parameters of a given seismic profiling application. For example, one source 1024 may be mounted at rig 1050 (see FIG. 10) or at another suitable location, and both vessels 1022 may serve as slave vessels with respect to the rig source 1024 or with respect to a source at another location.

However, a variety of source arrangements and implementations may be provided as desired for a given application. When utilizing dithered timing between the sources, for example, the master and slave locations of the sources may be adjusted according to the parameters of the specific seismic profiling application. In some applications, one of the source vessels 1022 (e.g., source vessel A in FIG. 10) may serve as the master source vessel while the other source vessel 1022 serves as the slave source vessel with dithered firing. However, an alternate source vessel 1022 (e.g., source vessel B in FIG. 10) may serve as the master source vessel while the other source vessel 1022 serves as the slave source vessel with dithered firing.

Similarly, the rig source 1024 may serve as the master source while one of the source vessels 1022 (e.g., vessel A) serves as the slave source vessel with dithered firing. The rig source 1024 also may serve as the master source while the other source vessel 1022 (e.g., vessel B) serves as the slave source vessel with dithered firing. In some applications, the rig source 1024 may serve as the master source while both of the source vessels 1022 serve as slave source vessels each with dithered firings. These and other arrangements may be used in achieving the desired synchronization of sources 1024 with the downhole acquisition system 1026.

The acoustic receivers 1028 of data acquisition system 1026 may be deployed in borehole 1030 via a variety of delivery systems, such as wireline delivery systems, slickline delivery systems, and other suitable delivery systems. Although a single acoustic receiver 1028 could be used in the borehole 1030, the illustrated embodiment includes a plurality of receivers 1028 that may be located in a variety of positions and orientations. The acoustic receivers 1028 may be configured for sonic and/or seismic reception. Additionally, the acoustic receivers 1028 may be communicatively coupled with processing equipment 1058 located downhole. By way of example, processing equipment 1058 may include a telemetry system for transmitting data from acoustic receivers 1028 to additional processing equipment 1059 located at the surface, e.g., on the rig 1050 and/or vessels 1022.

Depending on the specifics of a given data communication system, examples of surface processing equipment 1059 may include a radio repeater 1060, an acquisition and logging unit 1062, and a variety of other and/or additional signal transfer components and signal processing components. The radio repeater 1060 along with other components of processing equipment 1059 may be used to communicate signals, e.g., UHF and/or VHF signals, between vessels 1022 and rig 1050 and to enable further communication with downhole data acquisition system 1026.

It should be noted the UHF and VHF signals may be used to supplement each other. In general, the UHF band supports a higher data rate throughput but may be susceptible to obstructions and has less range. The VHF band is less susceptible to obstructions and has increased radio range but its data rate throughput is lower. In FIG. 10, for example, the VHF communications are illustrated as "punching through" an obstruction in the form of a production platform.

In some applications, the acoustic receivers 1028 are coupled to surface processing equipment 1059 via a hardwired connection. In other embodiments, wireless or optical connections may be employed. In still other embodiments, combinations of coupling techniques may be employed to relay information received downhole via the acoustic receivers 1028 to an operator and/or control system located at least in part at the surface.

In addition to providing raw or processed data uphole to the surface, the coupling system, e.g. downhole processing equipment 1058 and surface processing equipment 1059, may be designed to transmit data or instructions downhole to the acoustic receivers 1028. For example, the surface processing equipment 1059 may include a synchronization unit which coordinates the firing of sources 1024, e.g. dithered (delayed) source arrays, with the acoustic receivers 1028 located in borehole 1030. According to one embodiment, the synchronization unit uses coordinated universal time to ensure accurate timing. In some cases, the coordinated universal time system 1040 is employed in cooperation with global positioning system (GPS) 1038 to obtain UTC data from the GPS receivers of GPS 1038.

FIG. 10 includes three-dimensional vertical seismic profiling but other applications may utilize rig/offset vertical seismic profiling or seismic profiling employing walkaway lines. An offset source may be provided by a source 1024 located on rig 1050, on a stationary vessel 1022, and/or on another stationary vessel or structure.

As an example, the overall seismic system 1020 may employ various arrangements of sources 1024 on vessels 1022 and/or rig 1050 with each location having at least one source/source array 1024 to generate acoustic source signals. The acoustic receivers 1028 of downhole acquisition system 1026 are configured to receive the source signals, at least some of which are reflected off a reflection boundary 1064 located beneath a sea bottom 1066. The acoustic receivers 1028 generate data streams that are relayed uphole to a suitable processing system via downhole telemetry/processing equipment 1058.

While the acoustic receivers 1028 generate data streams, the navigation system 1036 determines a real-time speed, position, and direction of each vessel 1022 and also estimates initial shot times accomplished via signal generators 1054 of the appropriate source arrays 1024. A source controller may be part of surface processing equipment 1059 (located on rig 1050, on vessels 1022, or at other suitable locations 1032) and is designed to control firing of the acoustic source signals so that the timing of an additional shot time (e.g. a shot time via slave vessel 1057) is based on the initial shot time (e.g. a shot time via master vessel 1056) plus a dither value.

The synchronization unit of, for example, surface processing equipment 1059, coordinates the firing of dithered acoustic signals with recording of acoustic signals by the downhole acquisition system 1026. A processor system is configured to separate a data stream of the initial shot and a data stream of the additional shot via a coherency filter. As discussed above, however, other embodiments may employ pure simultaneous acquisition and/or may not perform separation of the data streams. In such cases, the dither is effectively zero.

After an initial shot time at T=0 (T0) is determined, subsequent firings of acoustic source arrays 1024 may be offset by a dither. The dithers may be positive or negative and sometimes are created as pre-defined random delays. Use of dithers facilitates the separation of simultaneous or near-simultaneous data sets to simplify the data processing. The ability to have the acoustic source arrays 1024 fire in simultaneous or near-simultaneous patterns reduces the overall amount of time used for three-dimensional vertical seismic profiling source acquisition. This, in turn, reduces rig time. As a result, the overall cost of the seismic operation is reduced, rendering the data intensive process much more accessible.

If the acoustic source arrays used in the seismic data acquisition are widely separated, the difference in move-outs across the acoustic receiver array of the wave fields generated by the acoustic sources 1024 may be sufficient to obtain a clean data image via processing the data without further special considerations. However, even when the acoustic sources 1024 are substantially co-located in time, data acquired by any of the methods involving dithering of the firing times of the individual sources 1024 described herein may be processed to a formation image leaving hardly any artifacts in the final image. This is accomplished by taking advantage of the incoherence of the data generated by one acoustic source 1024 when seen in the reference time of the other acoustic source 1024.

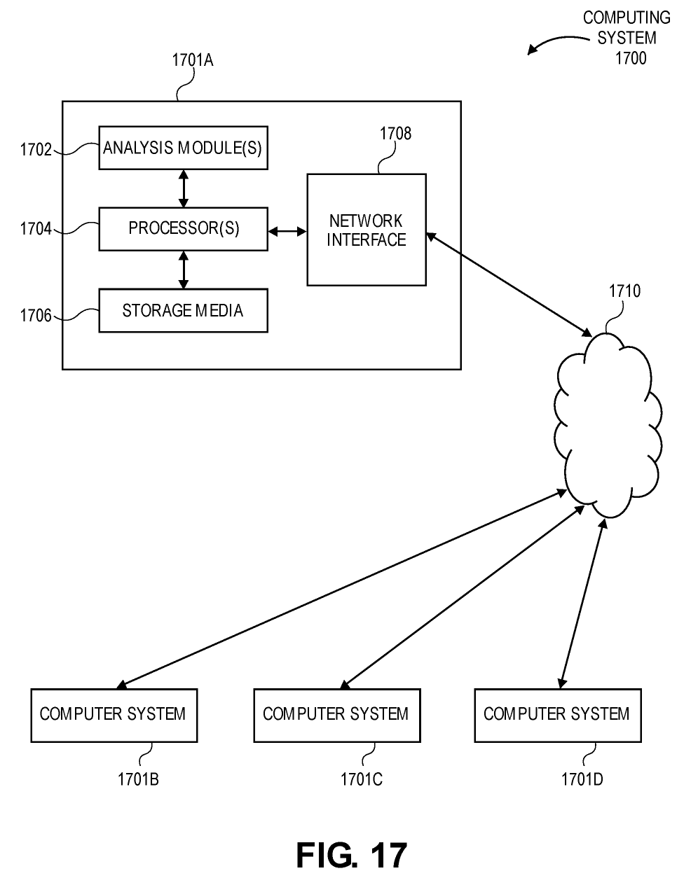

Attention is now directed to methods, techniques, and workflows for processing and/or transforming collected data that are in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement may include use of feedback loops executed on an algorithmic basis, such as at a computing device (e.g., computing system 1700, FIG. 17), and/or through manual control by a user who may make determinations regarding whether a given step, action, template, or model has become sufficiently accurate.

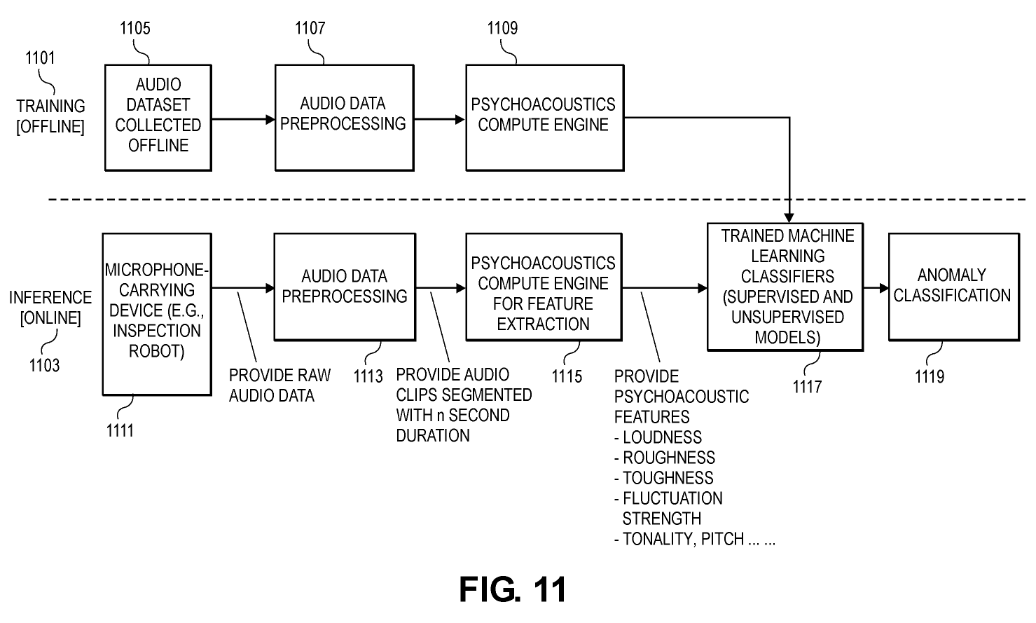

FIG. 11 illustrates the workflow for anomaly detection of oil and gas process equipment using psychoacoustics-based machine learning classifiers, which includes the pipelines of training 1101 and inference 1103. In the training pipeline 1101, the audio dataset collected 1105 offline is preprocessed 1107 into audio clips. In some configurations, the audio clips are segmented with an individual time duration of n seconds. The audio clips are used as inputs to compute psychoacoustic features or indicators such as loudness, roughness, toughness, fluctuation strength, pitch, and tonality, or any combination thereof. Loudness is the sensory scale of sound intensity. Sharpness is an attribute that is related to the timbre of a sound. Sharpness is the subjective attribute describing the perception of the spectral balance of a sound. It is the perceptual equivalent of the spectral centroid. Roughness and fluctuation strength are sensations induced by signal modulations. Pitch includes a subjective impression of frequency or how high or low a sound is perceived. Tonality includes identification of emerging tones over background noise to determine their contribution in the perception of a sound. These psychoacoustic features may be used as features to train machine learning classifiers. These machine learning classifiers may include supervised machines learning models 1109 (such as support vector machine (SVM), logistic regression, Naive Bayes, Decision tree, Random forest, K-nearest neighbors (KNN), and neural networks), and unsupervised machines learning models (such as K-means, and Density-based spatial clustering of applications with noise (DBSCAN), and Isolation forest). The training pipeline 1101 may be conducted offline. In the inference pipeline 1103, a microphone-carrying device 1111 such as an inspection robot may provide the raw audio data collected from the equipment for preprocessing 1113. In the preprocessing stage 1113, the raw audio data are segmented into clips with an individual time duration of n seconds. The processed audio clips are then transformed 1115 to psychoacoustic features such as loudness, roughness, toughness, fluctuation strength, pitch, and tonality, or any combination thereof. These psychoacoustic features are used as the inputs for the trained machine learning classifiers 1117, and the classifiers may finally output 1119 the classification of anomaly. Any of these operations may be executed in a cloud application and/or an edge application.

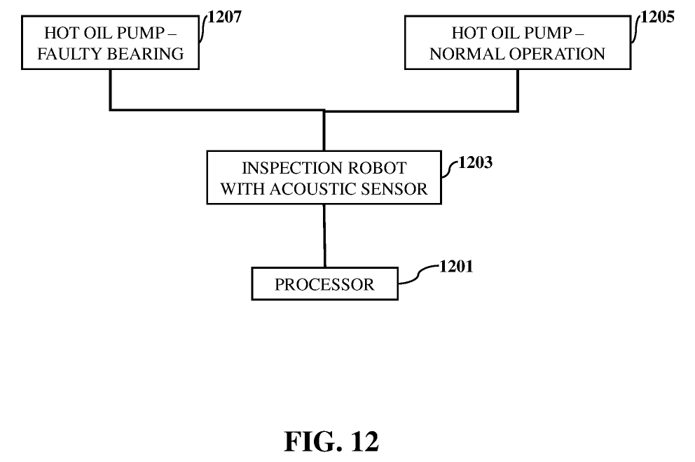

FIG. 12 illustrates an inspection robot 1203 collecting audio data by staying in proximity to the two centrifugal hot oil pumps 1205/1207 of interest. The robot 1203 carries a microphone that may record audio data and/or provide the audio data to the processor 1201. In some configurations, the robot 1203 collects high frequency data with a sampling rate of 48 kHz. Hot oil pump 1205 is under normal operational conditions, whereas hot oil pump 1207 operates abnormally with faulty motor bearing.

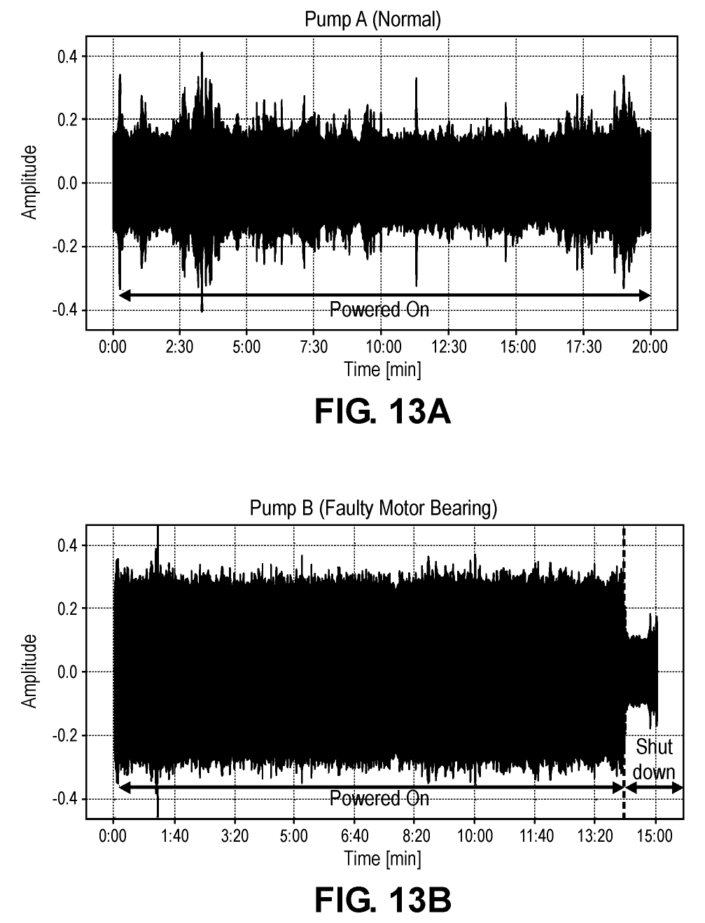

FIG. 13A illustrates raw audio signals recorded from hot oil pump 1205 (FIG. 12), and FIG. 13B illustrates raw audio signals recorded from hot oil pump 1207 (FIG. 12) (abnormal: faulty motor bearing) in terms of waveforms. In FIG. 13A, the audio data were recorded for about 20 minutes with Pump A powered on. In FIG. 13B, hot oil pump 1207 was powered on for about 14 minutes and afterwards shut down with sudden decrease of amplitude during data recording.

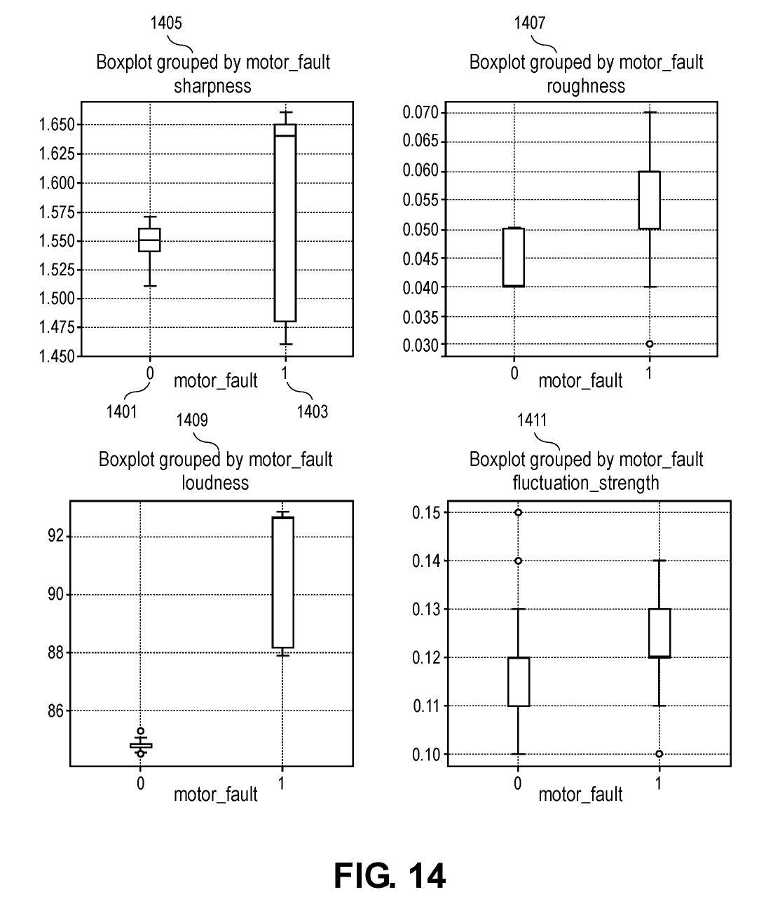

FIG. 14 illustrates the raw audio signals of FIGS. 13A and 13B segmented into clips with individual time duration of 10 seconds. The audio clips are transformed into psychoacoustic features (loudness 1409, sharpness 1405, roughness 1407, fluctuation strength 1411) as shown in the workflow in FIG. 11. FIG. 14 illustrates the boxplots grouped by motor fault status between various psychoacoustic features for hot oil pumps, where motor_fault 01401 represents normal status, and motor_fault 11403 denotes abnormal status with motor bearing fault. In the graphs, there is a correlation between psychoacoustic features and motor fault status, and it is expected that there is an increase in the loudness, roughness, and/or fluctuation strength in the presence of motor bearing fault based on the data.

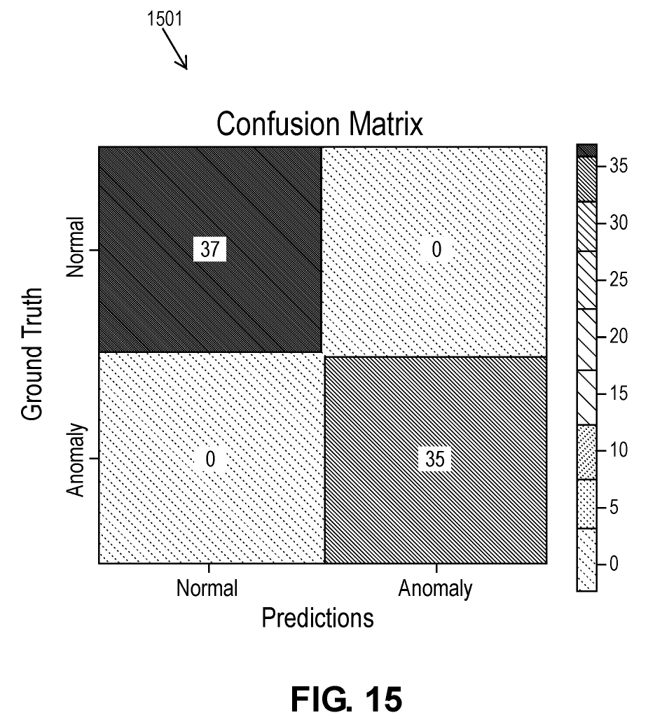

FIG. 15 illustrates the input and use of the psychoacoustic features (loudness, sharpness, roughness, fluctuation strength) to train a logistic regression model for binary classification. 70% of the total audio clips have been used for training, while 30% of the total audio clips have been used for testing. The confusion matrix 1501 may provide visual feedback on the model’s classification ability to predict true positives and true negatives along the diagonals, as shown in FIG. 15. It may be found that the developed model may correctly detect all 35 abnormal audio clips with faulty motor bearing and 37 normal audio clips in the test dataset.

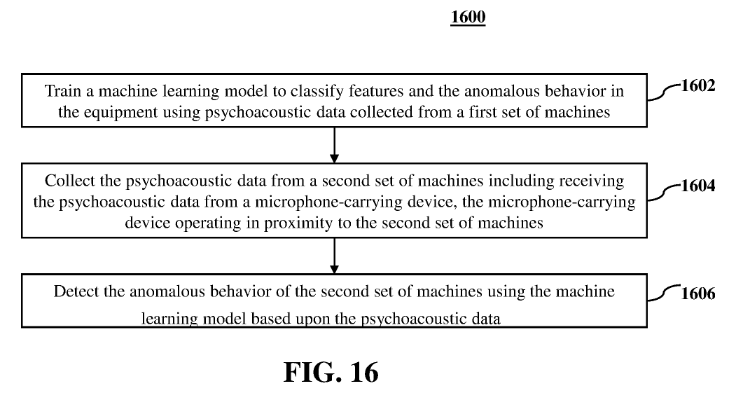

FIG. 16 illustrates a flowchart of method 1600 according to embodiments of the present disclosure. Method 1600 operable to detect anomalous behavior in equipment may include, but is not limited to including, training 1602 a machine learning model to classify features and the anomalous behavior in the equipment using psychoacoustic data collected from a first set of machines. The training may include, but is not limited to including, collecting the psychoacoustic data from the first set of machines, the first set of machines including oil and gas equipment, segmenting the collected psychoacoustic data into the audio clips based on the pre-selected criteria, training the machine learning model to recognize patterns in the features in the pre-processed audio clips, and training the machine learning model to determine the anomalous behavior based on the recognized patterns. The pre-processing may include denoising. The machine learning model may be or include, but is not limited to including, a support vector machine model, a logistic regression model, a Naive Bayes model, decision tree model, random forest model, a K-nearest neighbors model, a neural network model, a K-means model, a density-based spatial clustering of applications with noise model, a principal component analysis-based model, a t-distributed stochastic neighbor embedding-based model, and an isolation forest model. The features may include loudness, sharpness, roughness, fluctuation strength, pitch, and tonality, or any combination thereof, wherein the loudness includes a sensory scale of sound intensity, the sharpness includes a subjective attribute describing a perception of a spectral balance of a sound, the roughness includes sensations induced by the higher-frequency signal modulations, the fluctuation strength includes the sensations induced by the lower-frequency signal modulations, pitch includes a subjective impression of frequency or how high or low a sound is perceived, and tonality includes identification of emerging tones over background noise to determine their contribution in the perception of a sound. The pre-selected criteria may include time, background noise, and power status of the first set of machines. The first set of machines and the second set of machines may include oil and gas equipment.

Method 1600 may include collecting 1604 the psychoacoustic data from a second set of machines including receiving the psychoacoustic data from a microphone-carrying device, the microphone-carrying device operating in proximity to the second set of machines.

Method 1600 may include detecting 1606 the anomalous behavior of the second set of machines using the machine learning model based upon the psychoacoustic data.

In another embodiment, the action may be or include generating and/or transmitting a signal (e.g., using a computing system) that recommends, instructs, or causes a physical action to occur at a wellsite. The action may also or instead include performing the physical action at the wellsite. The physical action may include monitoring equipment, power cycling equipment, notifying maintenance personal of equipment failure, repairing and/or replacing the equipment, logging equipment behavior anomalies, or the like.

In some embodiments, the methods of the present disclosure may be executed by a computing system. FIG. 17 illustrates an example of such a computing system 1700, in accordance with some embodiments. The computing system 1700 may include a computer or computer system 1701A, which may be an individual computer system 1701A or an arrangement of distributed computer systems. The computer system 1701A includes one or more analysis modules 1702 that are configured to perform various tasks according to some embodiments, such as one or more methods disclosed herein. To perform these various tasks, the analysis module 1702 executes independently, or in coordination with, one or more processors 1704, which is (or are) connected to one or more storage media 1706. The processor(s) 1704 is (or are) also connected to a network interface 1707 to allow the computer system 1701A to communicate over a data network 1710 with one or more additional computer systems and/or computing systems, such as 1701B, 1701C, and/or 1701D (note that computer systems 1701B, 1701C and/or 1701D may or may not share the same architecture as computer system 1701A, and may be located in different physical locations, e.g., computer systems 1701A and 1701B may be located in a processing facility, while in communication with one or more computer systems such as 1701C and/or 1701D that are located in one or more data centers, and/or located in varying countries on different continents).

Continuing to refer to FIG. 17, a processor may include a microprocessor, microcontroller, processor module or subsystem, programmable integrated circuit, programmable gate array, or another control or computing device.

Continuing to refer to FIG. 17, the storage media 1706 may be implemented as one or more computer-readable or machine-readable storage media. Note that while in the example embodiment of FIG. 17 storage media 1706 is depicted as within computer system 1701A, in some embodiments, storage media 1706 may be distributed within and/or across multiple internal and/or external enclosures of computing system 1701A and/or additional computing systems. Storage media 1706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY^{®} disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

Continuing to refer to FIG. 17, in some embodiments, computing system 1700 contains one or more time-lapse seismic module(s) 1708. It should be appreciated that computing system 1700 is merely one example of a computing system, and that computing system 1700 may have more or fewer components than shown, may combine additional components not depicted in the example embodiment of FIG. 17, and/or computing system 1700 may have a different configuration or arrangement of the components depicted in FIG. 17. The various components shown in FIG. 17 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1700, FIG. 17), and/or through manual control by a user who may make determinations regarding whether a given step, action, template, model, or set of curves has become sufficiently accurate for the evaluation of the subsurface three-dimensional geologic formation under consideration.

Many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein may be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Many examples of equations and mathematical expressions have been provided in this disclosure. But those with skill in the art will appreciate that variations of these expressions and equations, alternative forms of these expressions and equations, and related expressions and equations that may be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

Those with skill in the art will appreciate that while the quoted sections of the article above that are provided for illustrative purposes include terms that could be interpreted as potentially absolute or requiring a given thing (including without limitation “exactly”, “exact”, “only”, “key”, “important”, “requires”, “all”, “each”, “must”, “always”, etc.), the various systems, methods, processing procedures, techniques, and workflows disclosed herein are not to be understood as limited by the use of these terms

In some embodiments, the multi-dimensional region of interest is selected from the group consisting of a subterranean region, human tissue, plant tissue, animal tissue, solid volumes, substantially solid volumes, volumes of liquid, volumes of gas, volumes of plasma, and volumes of space near and/or outside the atmosphere of a planet, asteroid, comet, moon, or other body.

The foregoing description, for the purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

1. A method operable to detect anomalous behavior in equipment, the method comprising:
training a machine learning model to classify features and the anomalous behavior in the equipment using psychoacoustic data collected from a first set of machines;
collecting the psychoacoustic data from a second set of machines including receiving the psychoacoustic data from a microphone-carrying device, the microphone-carrying device operating in proximity to the second set of machines; and
detecting the anomalous behavior of the second set of machines using the machine learning model based upon the psychoacoustic data.

2. The method of claim 1, wherein the training comprises:
collecting the psychoacoustic data from the first set of machines, the first set of machines including oil and gas equipment;
segmenting the collected psychoacoustic data into audio clips based on pre-selected criteria;
pre-processing the audio clips;
training the machine learning model to recognize patterns in the features in the pre-processed audio clips; and
training the machine learning model to determine the anomalous behavior based on the recognized patterns.

3. The method of claim 2, wherein the pre-selected criteria comprise:
time, background noise, and power status of the first set of machines.

4. The method of claim 1, further comprising:
converting the psychoacoustic data from the second set of machines into audio clips based on pre-selected criteria, wherein psychoacoustic features are extracted from the audio clips; and
providing the psychoacoustic features to the machine learning model.

5. The method of claim 1, wherein the machine learning model comprises:
a support vector machine model, a logistic regression model, a Naive Bayes model, a decision tree model, a random forest model, a K-nearest neighbors model, a neural network model, a K-means model, a density-based spatial clustering of applications with noise model, a principal component analysis-based model, a t-distributed stochastic neighbor embedding-based model, and an isolation forest model.

6. The method of claim 1, wherein the features comprise:
loudness, sharpness, roughness, fluctuation strength, pitch, and tonality, or any combination thereof, wherein the loudness includes a sensory scale of sound intensity, the sharpness includes a subjective attribute describing a perception of a spectral balance of a sound, the roughness includes sensations induced by higher-frequency signal modulations, and the fluctuation strength includes the sensations induced by lower-frequency signal modulations, the pitch includes a subjective impression of frequency or how high or low the sound is perceived, and the tonality includes identification of emerging tones over background noise to determine their contribution in the perception of the sound.

7. The method of claim 1, further comprising:
taking an action based on the anomalous behavior.

8. The method of claim 7, wherein the action comprises:
power-cycling the second set of machines, re-assessing the second set of machines, repairing the second set of machines, and/or providing the anomalous behavior to a display or storage device.

9. The method of claim 1, wherein the first set of machines and the second set of machines comprise:
oil and gas equipment.

10. A computing system operable to detect anomalies in equipment, the computing system comprising:
one or more processors; and
a memory system comprising one or more non-transitory computer-readable media storing instructions that, when executed by at least one of the one or more processors, cause the computing system to perform operations, the operations comprising:
training a machine learning model to classify features and anomalous behavior in the equipment using psychoacoustic data collected from a first set of machines;
collecting the psychoacoustic data from a second set of machines including receiving the psychoacoustic data from a microphone-carrying device, the microphone-carrying device operating in proximity to the second set of machines; and
detecting the anomalous behavior of the second set of machines using the machine learning model based upon the psychoacoustic data.

11. The computing system of claim 10, wherein the training comprises:
collecting the psychoacoustic data from the first set of machines, the first set of machines including oil and gas equipment;
segmenting the collected psychoacoustic data into audio clips based on pre-selected criteria;
pre-processing the audio clips, the pre-processing including denoising;
training the machine learning model to recognize patterns in the features in the pre-processed audio clips, the machine learning model including a support vector machine model, a logistic regression model, a Naive Bayes model, a decision tree model, a random forest model, a K-nearest neighbors model, a neural network model, a K-means model, a density-based spatial clustering of applications with noise model, a principal component analysis-based model, a t-distributed stochastic neighbor embedding-based model, and an isolation forest model; and
training the machine learning model to determine the anomalous behavior based on the recognized patterns.

12. The computing system of claim 10, further comprising:
converting the psychoacoustic data from the second set of machines into audio clips based on pre-selected criteria, wherein psychoacoustic features are extracted from the audio clips; and
providing the psychoacoustic features to the machine learning model.

13. The computing system of claim 10, wherein the features comprise:
loudness, sharpness, roughness, fluctuation strength, pitch, and tonality, or any combination thereof, wherein the loudness includes a sensory scale of sound intensity, the sharpness includes a subjective attribute describing a perception of a spectral balance of a sound, the roughness includes sensations induced by higher-frequency signal modulations, and the fluctuation strength includes the sensations induced by lower-frequency signal modulations, the pitch includes a subjective impression of frequency or how high or low the sound is perceived, and the tonality includes identification of emerging tones over background noise to determine their contribution in the perception of the sound.

14. The computing system of claim 10, wherein the operations further comprise:
taking an action based on the anomalous behavior, wherein the action includes power-cycling the second set of machines, re-assessing the second set of machines, repairing the second set of machines, and/or providing the anomalous behavior to a display or storage device.

15. A non-transitory computer-readable medium storing instructions that, when executed by one or more processors of a computing system, cause the computing system to perform operations operable to detect anomalous behavior in equipment, the operations comprising:
training a machine learning model to classify features and the anomalous behavior in the equipment using psychoacoustic data collected from a first set of machines;
collecting the psychoacoustic data from a second set of machines including receiving the psychoacoustic data from a microphone-carrying device, the microphone-carrying device operating in proximity to the second set of machines; and
detecting the anomalous behavior of the second set of machines using the machine learning model based upon the psychoacoustic data.

16. The non-transitory computer-readable medium of claim 15, wherein the training comprises:
collecting the psychoacoustic data from the first set of machines, the first set of machines including oil and gas equipment;
segmenting the collected psychoacoustic data into audio clips based on pre-selected criteria;
pre-processing the audio clips, the pre-processing including denoising;
training the machine learning model to recognize patterns in the features in the pre-processed audio clips; and
training the machine learning model to determine the anomalous behavior based on the recognized patterns.

17. The non-transitory computer-readable medium of claim 15, further comprising:
converting the psychoacoustic data from the second set of machines into audio clips based on pre-selected criteria, wherein psychoacoustic features are extracted from the audio clips; and
providing the psychoacoustic features to the machine learning model.

18. The non-transitory computer-readable medium of claim 15, wherein the features comprise:
loudness, sharpness, roughness, fluctuation strength, pitch, and tonality, or any combination thereof, wherein the loudness includes a sensory scale of sound intensity, the sharpness includes a subjective attribute describing a perception of a spectral balance of a sound, the roughness includes sensations induced by higher-frequency signal modulations, and the fluctuation strength includes the sensations induced by lower-frequency signal modulations, the pitch includes a subjective impression of frequency or how high or low the sound is perceived, and the tonality includes identification of emerging tones over background noise to determine their contribution in the perception of the sound.

19. The non-transitory computer-readable medium of claim 15, wherein the operations further comprise:
taking an action based on the anomalous behavior, wherein the action includes power-cycling the second set of machines, re-assessing the second set of machines, repairing the second set of machines, and/or providing the anomalous behavior to a display or storage device.

20. The non-transitory computer-readable medium of claim 15, wherein the machine learning model comprises:
a support vector machine model, a logistic regression model, a Naive Bayes model, a decision tree model, a random forest model, a K-nearest neighbors model, a neural network model, a K-means model, a density-based spatial clustering of applications with noise model, a principal component analysis-based model, a t-distributed stochastic neighbor embedding-based model, and an isolation forest model.
